(19) United States
(12) Patent Application Publication
(10) Pub. No.: US 2025/0307707 A1
(43) Pub. Date: Oct. 2, 2025

(54) EVALUATING PROBABILISTIC FAIRNESS OF MACHINE LEARNING CLASSIFICATION MODELS

(71) Applicant: FMR LLC, Boston, MA (US)

(72) Inventors: Melinda Thielbar, Durham, NC (US); Serdar Kadioglu, Somerville, MA (US)

(21) Appl. No.: 19/091,266

(22) Filed: Mar. 26, 2025

Related U.S. Application Data
(60) Provisional application No. 63/571,245, filed on Mar. 28, 2024.

(51) Int. Cl. G06N 20/00

(52) U.S. Cl. CPC G06N 20/00

(57) ABSTRACT

Methods and apparatuses for evaluating probabilistic fairness of machine learning (ML) classification models include a server that generates a first input data set, including assigning a class membership label to each of a plurality of participants based upon a probability of class membership derived from a surrogate class variable. The server generates a second input data set, including assigning a class membership label to each of the plurality of participants based upon ground truth class values. The server executes a binary classification model on the first input data set to generate inferred fairness metrics for the binary classification model. The server executes the binary classification model on the second input data set to generate actual fairness metrics for the binary classification model. The server determines a disparity in one or more fairness metrics for the binary classification model based upon a comparison of the inferred fairness metrics to the actual fairness metrics.

### RELATED APPLICATIONS

This application claims priority to U.S. Provisional Patent Application No. 63/571,245, filed on Mar. 28, 2024, the entirety of which is incorporated herein by reference.

### TECHNICAL FIELD

This application relates generally to methods and apparatuses, including computer program products, for evaluating probabilistic fairness of machine learning (ML) classification models.

### BACKGROUND

Artificial Intelligence/Machine Learning (AI/ML) models must be tested for fairness to verify that the models are equally performant for individuals regardless of gender, race, religion, or other protected status. To accomplish this goal, existing fairness methodologies seek to collect and store certain confidential, private, and/or sensitive data for each individual. Typically, these existing fairness methods take one of two approaches: 1) dividing people into groups based on demographics and calculating model metrics separately for each group, or 2) predicting characteristics for each individual and then applying the predicted characteristics to groups for calculating model metrics. Both cases require that the modeler have access to private data of individuals that is associated with protected status, either to perform grouping of individuals or to build the predictive model for group membership. However, in many cases this private data is sparse, unavailable, or even illegal to collect.

### SUMMARY

To overcome the above challenges, the methods and systems described herein extend binary fairness metrics from deterministic membership to its surrogate counterpart under a probabilistic setting. Using these techniques, it is possible to conduct binary fairness evaluation when exact protected attributes are not available, but their surrogates as likelihoods are accessible. In addition, inferred metrics calculated from surrogates are proven valid under standard statistical assumptions. Moreover, the inferred metrics do not require the surrogate variable to be strongly related to protected class membership. They remain valid even when membership in the protected and unprotected groups is equally likely for many groups of the surrogate variable.

Beneficially, the techniques described herein do not require private data of individuals. Instead, the methods and systems use surrogate class variables, where the probability of having certain traits is known at the group level for each variable. Also, the techniques use data summarized at the surrogate group level to infer the change in model metrics as the probability of different traits changes. This allows for the calculation of the difference in model metrics between people who have different characteristics.

As can be appreciated, a primary motivation behind the methods and systems herein is to enable fairness evaluation of binary AI models (e.g., models that output a binary value, such as Yes/No, 0/1, Positive/Negative) in scenarios where a protected attribute of individuals (e.g., legally defined as age, race, sex, marital status, or other attributes) is unknown. In practice, access to such private information is either limited, the information is simply not available, or it may even be illegal to ask for such information. Therefore, the techniques use a more relaxed definition of group membership, the so-called surrogate, instead of individual membership. The group level information is an alternative that reveals the likelihood of belonging to a protected group.

For example, instead of knowing whether an individual is part of a protected or unprotected class with 100% certainty (as this is hard to obtain, private information at the individual level), the systems and methods only require certain group-based information, i.e., 90% of people in a specific zip code are in an unprotected class. This alternative is easier to obtain, and possible public information, at group level without revealing anything about individuals. The approach described in this application shows that if fairness metrics are calculated using the precise individual information (which is current state-of-the-art) versus using likelihood-based group information (described herein), the metrics turn out to be the same, both in theory and practice. This opens the door to conduct fairness testing of AI models for scenarios where fairness evaluation was impossible previously.

The invention, in one aspect, features a computer system for evaluating probabilistic fairness of machine learning (ML) classification models. The system includes a server computing device with a memory that stores computer-executable instructions and a processor that executes the computer-executable instructions. The server computing device connects to a remote computing environment hosting a binary classification model via a programmatic interface. The server computing device generates a first input data set for evaluating fairness of a binary classification model, including assigning a class membership label to each of a plurality of participants based upon a probability of class membership derived from a surrogate class variable. The server computing device generates a second input data set for evaluating fairness of the binary classification model, including assigning a class membership label to each of the plurality of participants based upon ground truth class values. The server computing device executes the binary classification model on the first input data set to generate inferred fairness metrics for the binary classification model. The server computing device executes the binary classification model on the second input data set to generate actual fairness metrics for the binary classification model. The server computing device determines a disparity in one or more of the fairness metrics for the binary classification model based upon a comparison of the inferred fairness metrics to the actual fairness metrics. The server computing device modifies one or more features of the binary classification model based upon the disparity and rebuilds the binary classification model.

The invention, in another aspect, features a computerized method of evaluating probabilistic fairness of machine learning (ML) classification models. A server computing device connects to a remote computing environment hosting a binary classification model via a programmatic interface. The server computing device generates a first input data set for evaluating fairness of a binary classification model, including assigning a class membership label to each of a plurality of participants based upon a probability of class membership derived from a surrogate class variable. The server computing device generates a second input data set for evaluating fairness of the binary classification model, including assigning a class membership label to each of the plurality of participants based upon ground truth class values. The server computing device executes the binary classification model on the first input data set to generate inferred fairness metrics for the binary classification model. The server computing device executes the binary classification model on the second input data set to generate actual fairness metrics for the binary classification model. The server computing device determines a disparity in one or more of the fairness metrics for the binary classification model based upon a comparison of the inferred fairness metrics to the actual fairness metrics. The server computing device modifies one or more features of the binary classification model based upon the disparity and rebuilds the binary classification model.

Any of the above aspects can include one or more of the following features. In some embodiments, the class membership label corresponds to a protected class or an unprotected class. In some embodiments, the surrogate class variable is used to separate the plurality of participants into one or more groups. In some embodiments, the inferred fairness metrics comprise one or more of: statistical parity, equal opportunity, predictive equality, or average odds. In some embodiments, the actual fairness metrics are statistical parity, equal opportunity, predictive equality, or average odds. In some embodiments, determining a disparity in one or more of the fairness metrics for the binary classification model comprises comparing each inferred fairness metric to a corresponding actual fairness metric to determine a difference in values. In some embodiments, modifying one or more features of the binary classification model based upon the disparity and rebuilding the binary classification model results in a modified binary classification model that exhibits improved fairness in classifying data

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the technology described above, together with further advantages, may be better understood by referring to the following description taken in conjunction with the accompanying drawings. The drawings are not necessarily to scale, emphasis instead generally being placed upon illustrating the principles of the technology.

FIG. 1 is a block diagram of a system for evaluating probabilistic fairness of machine learning (ML) classification models.

FIG. 2 is a block diagram of a computerized method of evaluating probabilistic fairness of ML classification models.

FIG. 3 is a diagram of an illustrative Probabilistic Membership Problem (PMP) example for credit loan default prediction.

FIG. 4 is a table which compares the fairness statistics on Home Mortgage Disclosure Act (HMDA) data using self-reported race versus inferred metrics calculated with zip code as the surrogate,

FIG. 5 is a detailed flow diagram of a method for generating the first input data set for evaluating fairness of a binary classification model,

FIG. 6 is a table which provides simulation rates for [symbol] (FPR, FNR, P (ML(X)=1) [symbol] in the synthetic benchmarks between protected and unprotected groups.

FIG. 7 is a diagram of an algorithmic procedure to run simulations of a biased binary classifier to define the confusion matrix and assign participants into a quadrant in the matrix.

FIG. 8 is a diagram of a workflow for implementing the algorithm of FIG. 7 to define the confusion matrix, assign participants into a quadrant in the matrix, generate model metrics, and return model disparity.

FIG. 9 is a table which provides simulation results from actual and inferred metrics on various unfairness settings.

FIG. 10 is a detailed flow diagram of a method for determining a disparity in one or more of the fairness metrics for the binary classification model based upon a comparison of the inferred fairness metrics to the actual fairness metrics.

FIGS. 11A and 11B are diagrams that show graphs comparing the estimates of Statistical Parity for the inferred metric and a set of model-based estimators of varying performance under the fairness scenarios described in the table of FIG. 6.

### DETAILED DESCRIPTION

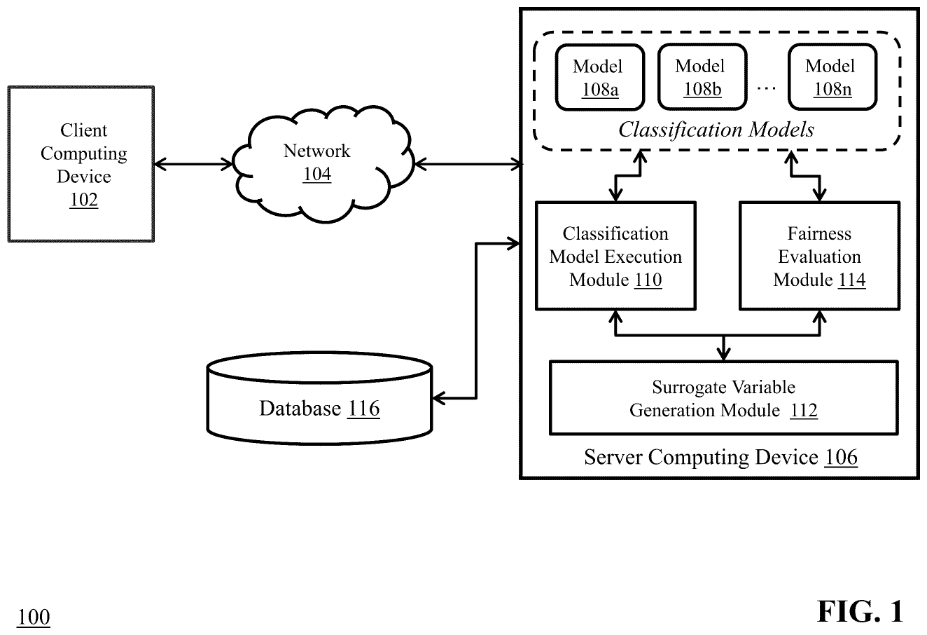

FIG. 1 is a block diagram of system 100 for evaluating probabilistic fairness of machine learning (ML) classification models. System 100 includes client computing device 102, communications network 104, server computing device 106 that includes a plurality of artificial intelligence classification models 108a-108n, classification model execution module 110, surrogate variable generation module 112, and fairness evaluation module 114, and a database 116.

Client computing device 102 connects to communications network 104 in order to communicate with server computing device 106 to provide input and receive output relating to the process of evaluating probabilistic fairness of ML classification models as described herein. Exemplary client computing devices 102 include but are not limited to computing devices such as smartphones, tablets, laptops, desktops, smart watches, IP telephony devices, internet appliances, or other devices capable of establishing a communication session with server computing device 106. It should be appreciated that other types of devices that are capable of connecting to the components of system 100 can be used without departing from the scope of the technology described herein.

Communications network 104 enables client computing device 102 to communicate with server computing device 106. Network 104 is typically a wide area network, such as the Internet and/or a cellular network. In some embodiments, network 104 is comprised of several discrete networks and/or sub-networks (e.g., cellular to Internet, PSTN to Internet, PSTN to cellular, etc.).

Server computing device 106 is a device including specialized hardware and/or software modules that execute on a processor and interact with memory modules of server computing device 106, to receive data from other components of system 100, process data, transmit data to other components of system 100, and perform functions for evaluating probabilistic fairness of ML classification models as described herein. Server computing device 106 includes a plurality of artificial intelligence classification models 108a-108n (such as binary classification models that are configured to return a ‘binary’ classification result—e.g., Yes/No, 0/1, etc.—from an input data set) executing on one or more processors of device 106, and several computing modules 110, 112, 114 that execute on one or more processors of server computing device 106. In some embodiments, modules 110, 112, 114 are specialized sets of computer software instructions programmed onto one or more dedicated processors in server computing device 106 and can include specifically-designated memory locations and/or registers for executing the specialized computer software instructions.

Although classification models 108a-108n and computing modules 110, 112, 114 are shown in FIG. 1 as executing within the same server computing device 106, in some embodiments, models 108a-108n and/or the functionality of modules 110, 112, 114 can be distributed among a plurality of server computing devices. As shown in FIG. 1, server computing device 106 enables models 108a-108n and modules 110, 112, 114 to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the technology described herein.

Database 116 is located on a computing device (or in some embodiments, a set of computing devices) coupled to server computing device 106 and database 116 is configured to receive, generate, and store specific segments of data relating to the process of evaluating probabilistic fairness of ML classification models as described herein. In some embodiments, all or a portion of database 116 can be integrated with server computing device 106 or be located on a separate computing device or devices. Database 116 can comprise one or more databases configured to store portions of data used by the other components of system 100.

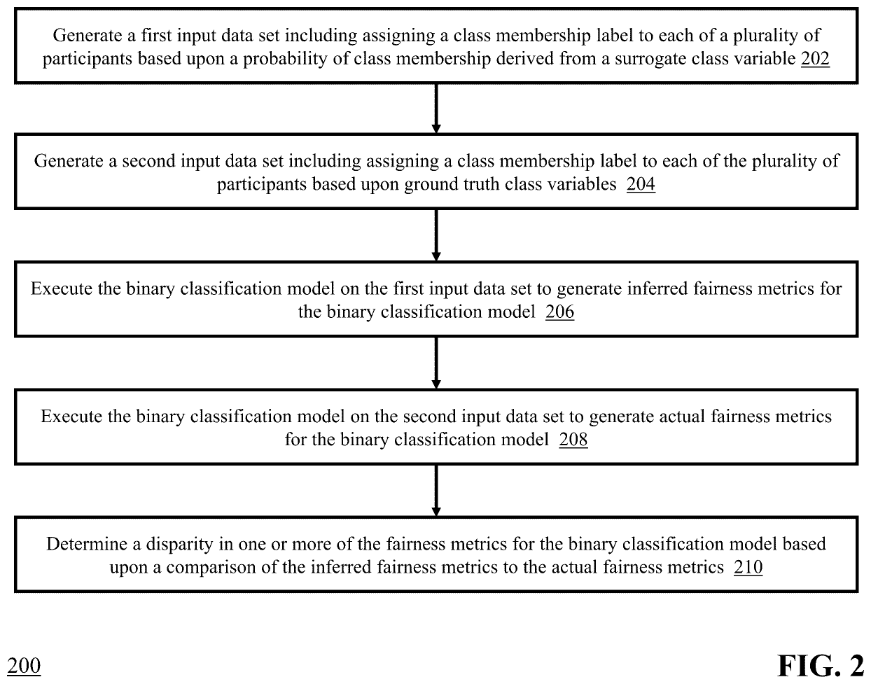

FIG. 2 is a block diagram of a computerized method 200 of evaluating probabilistic fairness of ML classification models, using system 100 of FIG. 1. As an illustrative example, the method 200 of evaluating probabilistic fairness of ML classification models will be described below in the context of a Probabilistic Membership Problem (PMP) for credit loan default prediction across a population X with protected (X^{T}) and unprotected (X^{⊥}) cohorts. It should be appreciated that the methods and systems can be applied to other problems or contexts without departing from the scope of the technology herein.

In this Probabilistic Membership Problem, consider a population, X, with individuals, x∈X, that is divided into two cohorts by a class membership attribute A∈{T, ⊥} such that T and ⊥ represent protected and unprotected membership, respectively. Let X=X^{T} ∪X^{⊥}.

For practical reasons, e.g., privacy concerns, the protected information of each individual remains unknown, i.e., x [symbol] {X^{T}, X^{⊥} }, but there exists a surrogate grouping so that membership in the surrogate group reveals the probability of being protected, i.e. P_{z}(x∈X^{T})∀x∈z. Note that P_{z}(x∈X^{T})=1−P_{z}(x∈X^{⊥}) and every individual belongs to exactly one surrogate group, ∃lz∈Z∧x∈z, ∀x.

Consider a binary classification model trained on historical data to make predictions about individuals, ML(x). We would like to evaluate this model against unwanted bias between X^{T} and X^{⊥}. Let m be a model metric, e.g., statistical parity, true positive rate, false positive rate, etc. The goal of the Probabilistic Membership Problem (PMP) is to estimate the disparity in the model metric m between the protected and unprotected cohorts, i.e., m(X^{T})−m(X^{⊥}). Contrary to its deterministic counterpart, in PMP, the protected attribute of individuals remains unknown. Instead, a probability Pz (x∈X^{T}) at the group level, ∀x∈z and ∀z∈Z, is known.

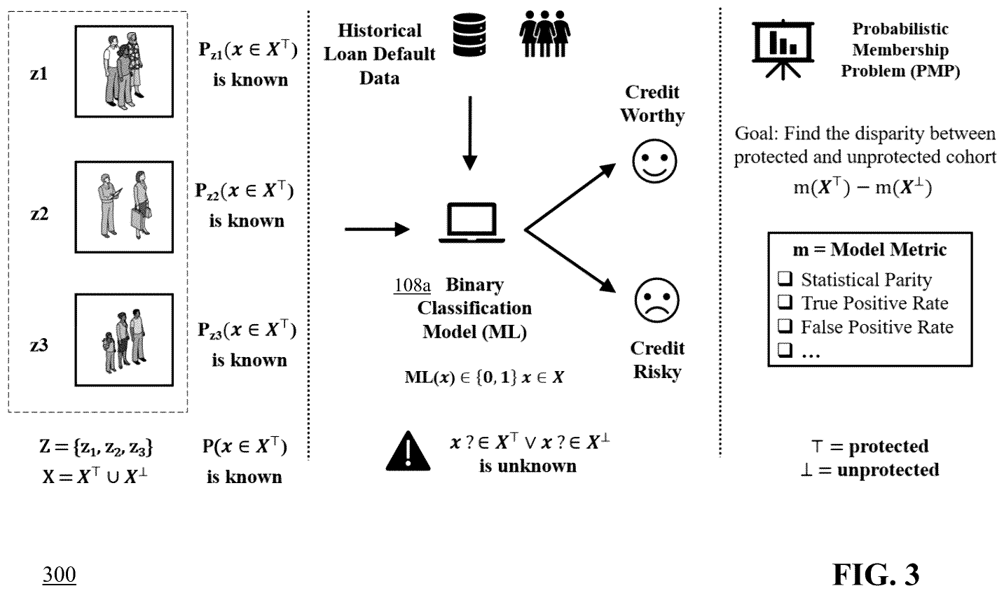

FIG. 3 is a diagram of an illustrative PMP example 300 for credit loan default prediction across a population X with protected, X^{T}, and unprotected, X^{⊥}, cohorts. Let us demonstrate how PMP [symbol] X, Z, P_{z}(x∈X^{T}, m [symbol] captures practical fairness scenarios in various domains. This example considers the classical setting for predicting successful credit applications. For that purpose, a binary classification model (e.g., model 108a) is trained on the historical loan behavior of customers to predict who is credit-worthy in the future. As mentioned above, there are two cohorts in the population X; protected, X^{T}, and unprotected, X^{⊥}. In some embodiments, the protected membership can be based on any attribute A that is legally protected against discrimination (e.g., gender, race, age, or marital status). Further, there are three surrogate groups Z={z1, z2, z3}, e.g., zip codes. The probability of being in the protected cohort is known within each surrogate group. However, the protected attribute of each individual remains unknown. The goal of PMP is to find the machine learning model 108a disparity between the protected and unprotected cohorts, m(X^{T})−m(X^{⊥}), for a given model metric, m.

Imagine A∈{T,⊥} denotes race as in white and non-white. As defined in PMP, we do not have access to such personal information of individuals, e.g., due to privacy constraints. The absence of confidential protected attributes is often the case in reality, and unfortunately, all existing binary fairness evaluation metrics that require protected membership information become invalid in these cases, as described in M. Andrus et al., “What We Can't Measure, We Can't Understand: Challenges to Demographic Data Procurement in the Pursuit of Fairness,” In Proceedings of the 2021 ACM Conference on Fairness, Accountability, and Transparency, 2021, pp. 249-260. This gap is addressed by the methods and systems described herein.

The primary motivation behind PMP is that the absence of protected attributes should not jeopardize the evaluation of machine learning models against fairness metrics, here m, to surface potential unwanted bias.

As a remedy, we assume access to a surrogate variable, Z, e.g., the zip code of the population that provides the likelihood of protected membership, P_{z} (x∈X^{T}), at the group level for individuals in the same zip code area, x∈z. Here we have three zip codes where the probability of white and non-white cohorts is known, e.g., gathered from the publicly available Census data. The goal of PMP is to leverage this surrogate zip code information to find the model disparity m(X^{T})−m(X^{⊥}) between white and non-white cohorts to conduct fairness evaluation.

To address PMP, we show below that, if Z is available and the calculation for m can be expressed as an arithmetic mean, then the system 100 can infer the model metric disparity, i.e., m(X^{T})−m(X^{⊥}), under standard statistical conditions. We call these estimates inferred metrics obtained from surrogate membership. Then, the system 100 can utilize inferred metrics for fairness evaluation. Without the approach as proposed herein to infer these metrics, binary fairness evaluation would not be possible when protected membership is absent. The approach for calculating the inferred metrics for the PMP leveraging surrogate membership is described in detail below.

Let m be a model measure that can be expressed as an arithmetic mean and let m(X^{T})−m(X^{⊥}) be the model fairness disparity metric we would like to estimate. Then, by the linearity property of expectation (as described in A. Papoulis, “Expected Value; Dispersion; Moments,” § 5-4 in Probability, Random Variables, and Stochastic Processes, 2nd ed., New York: McGraw-Hill, pp. 139-152 (1984)), the model measure for each level of Z, denoted by m_{z}, can be approximated by a linear combination of the model measures for groups X^{T} and X^{⊥} weighted by the population proportions of each group within z:

$${m}_{z} = {P}_{z} ( x ∈ {X}^{⊤} ) m ( {X}^{⊤} ) + {P}_{z} ( x ∈ {X}^{⊥} ) m ( {X}^{⊥} ) \qquad Equation 1$$

In the example shown in FIG. 3, we assumed to know P_{z} (x∈X^{T}), P_{z} (x∈X^{⊥}), and m_{z} without error, i.e., we measured the entire population. This would allow us to solve group-level metrics arithmetically using a system of equations.

In practice, we do not have access to the entire population; hence our model metrics cannot be exact. As a result, there will be some error within each m_{z}. Accordingly, we express m_{z} with an error term as:

$${m}_{z} = {P}_{z} ( x ∈ {X}^{⊤} ) m ( {X}^{⊤} ) + {P}_{z} ( x ∈ {X}^{⊥} ) m ( {X}^{⊥} ) + {e}_{z} \qquad Equation 2$$

where each e_{z} remains unknown.

The addition of e_{z} means we can no longer solve Equation 2 as a system of linear equations as in Equation 1. Therefore, we need an optimization solution that will allow us to estimate m(X^{T}) and m(X^{⊥}) with the minimum error. To achieve that, let us re-write Equation 2 into a form that lends itself to this kind of estimation.

Remember that we have two groups: protected, T, and unprotected, L, and each individual is classified into exactly one group. Then P_{z} (x∈X^{T})=1−P_{z} (x∈X^{⊥}), and we can re-write Equation 2 as:

$${m}_{z} = {P}_{z} ( x ∈ {X}^{⊤} ) m ( {X}^{⊤} ) + ( 1 - {P}_{z} ( x ∈ {X}^{⊤} ) ) m ( {X}^{⊥} ) + {e}_{z} \qquad Equation 3$$

$${m}_{z} = m ( {X}^{⊥} ) + ( m ( {X}^{⊤} ) - m ( {X}^{⊥} ) ) {P}_{z} ( x ∈ {X}^{⊤} ) + {e}_{z} \qquad Equation 4$$

The critical insight behind our approach is to replace the unknown m(X^{T}) and m(X^{⊥}) with parameters from Linear Regression:

$${m}_{z} = {β}_{0} + {β}_{1} {P}_{z} ( x ∈ {X}^{⊤} ) + {e}_{z} \qquad Equation 5$$

where β₀=m(X^{T}), and β₁=m(X^{T})−m(X^{⊥}).

With this transformation, notice how β₁ neatly captures the disparity of the model metric between the two cohorts.

For linear relationships as described in Equation 5, the method of Ordinary Least Squares (OLS) is the standard estimation technique for β₀ and β₁. Under the following assumptions, the Gauss-Markov theorem states that ordinary least squares estimators for β₀ and β₁ are unbiased and have minimum variance:
(1) The error terms e_{z} must have an expected value of zero given the value P_{z} (x∈X^{T}), i.e. E[e_{z}| P_{z} (x∈X^{T})]=0. In our case, this condition is met by assuming m can be expressed as an arithmetic mean. This allows us to write m_{z} as a linear function of the population values of m(X^{T}), m(X^{⊥}), and P_{z} (x∈X^{T}).
(2) The error terms ez must be iid. In our case, this assumption is met if we assume that P(m_{z}, Z) and P(A, Z) are independent draws from their respective marginal distribution, where A∈{T,⊥} is the unknown class membership.
(3) Ordinary least squares requires that the variance of e_{z} be constant for all z. In our case, this assumption is violated because the error of a mean varies with the number of observations unless we observe exactly the same number of individuals in each category z. Therefore, we relax the equal variances assumption by using an alternative estimator called Weighted Ordinary Least Squares (WOLS) (as described in D. F. Heitjan, “Inference from Grouped Continuous Data: A Review,” Statistical Science Vol. 4, No. 2 (1989), pp. 164-179). The weight for each z is the number of observations for that level of Z. We denote this value as n_{z}.

To summarize the above, we made the connection between our metric m in PMP and the β parameters in WOLS. This connection allows us to leverage the WOLS estimator to infer the metrics we are interested in; precisely, m(X^{T}) and m(X^{⊥}). Overall, this allows us to capture the disparity in the model metric, m(X^{T})−m(X^{⊥}), between the protected and unprotected group for fairness evaluation. Below, we show how well-known fairness metrics can be neatly calculated given the inferred disparity metric.

As can be appreciated, many fairness metrics have been developed (as described in S. Caton and C. Haas, “Fairness in Machine Learning: A Survey,” arXiv:2010.04053v1 [cs.LG], Oct. 4, 2020). Herein, we consider the following standard metrics:

$$Statistical Parity = P ( ML ( x ) = 1 \vert x ∈ {X}^{⊤} ) - P ( ML ( x ) = 1 \vert x ∈ {X}^{⊥} )$$

$$Equal Opportunity = {TPR}_{⊤} - {TPR}_{⊥}$$

$$Predictive Equality = {FPR}_{⊤} - {FPR}_{⊥}$$

$$Average Odds = ( Predictive Equality + Equal Opportunity ) / 2$$

where TPR is the true positive rate, FPR is the False Positive Rate, and ML(x) is the predicted class. Considering statistics based on the TPR and FPR allows us to examine whether the inferred metrics are equally performant for fairness metrics calculated on different parts of the confusion matrix. Considering Average Odds shows that inferred metrics that are sums or differences of other inferred metrics and/or inferred metrics multiplied by constants are unbiased.

Our approach for solving PMP as described above requires inferred metrics be expressed as arithmetic means. Here we show that this holds for standard fairness metrics. Starting with Statistical Parity, we recall that the definition of the metric is as follows:

$$Statistical Parity = P ( ML ( x ) = 1 \vert x ∈ {X}^{⊤} ) - P ( ML ( x ) = 1 \vert x ∈ {X}^{⊤} ) \qquad Equation 6$$

We make the observation that probabilities are estimated by summing the number of individuals who are classified into the positive case for each group, e.g.;

$$P ( ML ( x ) = 1 \vert x ∈ {X}^{⊤} ) = \frac{1}{\vert {X}^{⊤} \vert} {\sum }_{x ∈ {X}^{⊤}} I ( ML ( x ) = 1 ) \qquad Equation 7$$

This is the arithmetic mean of the indicator function ML(x)=1. The probability of being predicted positive is, therefore, a suitable metricm that can be expressed as an arithmetic mean. Consequently, we can use surrogate membership for PMP to infer m(X^{T}) and m(X^{⊥}). The key observation in Equation 7 that probabilities can be expressed as arithmetic means allows us to calculate the other fairness statistics.

Next, we consider Equal Opportunity, which is the difference between the true positive rates for the protected and unprotected groups. The true positive rate is calculated as follows:

$$TPR = \frac{True Positives}{True Positives + False Negatives} = \frac{\sum I ( ML ( x ) = 1 ∧ Y = 1 )}{\sum I ( Y = 1 )}$$

where Y is the binary label for the model Y E {0, 1} and I is the indicator function.

If we divide the numerator and denominator of this equation by N, the total number of individuals, the calculation is unchanged, but TPR becomes an expression based on probabilities:

$$TPR = \frac{\frac{1}{N} \sum I ( ML ( x ) = 1 ∧ Y = 1 )}{\frac{1}{N} \sum I ( Y = 1 )} = \frac{P ( ML ( x ) = 1 ∧ Y = 1 )}{P ( Y = 1 )}$$

As with Statistical Parity, each of these probabilities can be expressed as an arithmetic mean of an indicator function. That means we can calculate them as inferred metrics. This idea allows us to infer a host of fairness metrics that are based on the confusion matrix for a binary classifier.

Even when fairness metrics can be expressed as arithmetic mean, one caveat still remains. While the expected values of the estimated probabilities are equal to their true population values, values that are functions of these probabilities are not guaranteed to have their true expectation. We solve this issue by using a resampling technique known as the bootstrap, where we draw multiple samples from our data with repetition and calculate a value for our statistic of interest for each sample. We then report the mean estimate from these samples as our bootstrapped estimate. The advantage of this method is two-fold. First, it allows us to produce a more robust estimate for our inferred statistics. Second, the variation within bootstrapped samples can be used to estimate the error incurred from inferred metrics instead of actual class values. A detailed treatment of the bootstrap methodology and the proof for its guarantee to yield true expected value is described in B. Efron and R. Tibshirani, “Bootstrap Methods for Standard Errors, Confidence Intervals, and Other Measures of Statistical Accuracy,” Statistical Science Vol. 1, No. 1, pp. 54-75 (1986).

To demonstrate the effectiveness of our approach when solving PMP in practice, we consider three specific questions:
Q1: How do our inferred metrics from surrogate membership compare to an oracle that produces exact fairness evaluation using deterministic membership? When the inferred disparity metric is used, how does fairness evaluation change, and are binary fairness metrics still within the same range as in the exact results?
Q2: How robust are our inferred metrics from surrogate membership under different scenarios with varying disparity conditions?
Q3: How do inferred metrics compare to existing model-based methods that estimate the probability of membership in the protected group and assign each individual to the most likely group?

To answer each question, we start with an overview of the dataset and the modeling setup. We then present numerical results with discussions.

Turning back to FIG. 2, surrogate variable generation module 112 of server computing device 106 generates (step 202) a first input data set for evaluating fairness of a binary classification model (e.g., model 108a), including assigning a class membership label to each of a plurality of participants based upon a probability of class membership derived from a surrogate class variable (e.g., the zip code of the population). As described above, we need a dataset that reveals protected information about individuals. The Home Mortgage Disclosure Act (HMDA) dataset (available from the Federal Financial Institutions Examination Council (FFIEC) at ffiec.cfpb.gov/data-publication/snapshot-national-loan-level-dataset/2018) fits our experimental purposes neatly. First, this publicly available dataset provides information on the self-reported race of 1.3 million mortgage applicants. Second, it also contains zip code data, which we use as our surrogate variable. We use the U.S. Census's American Community Survey (ACS) to acquire the probability of protected status based on race. Zip code estimates for race percentages were assigned based on the state and census tract with the highest ratio of residential addresses according to the 2018 Q4 HUD-USPS Crosswalk file (presented in A. Din and R. Wilson, “Crosswalking ZIP Codes to Census Geographies,” Cityscape Vol. 22, No. 1, pp. 293-314 (2020)). We drop 300,000 individuals who do not have valid zip codes and drop 9,460 zip codes that have less than thirty individuals.

To test the method described herein on the HMDA data, we need a binary classifier to evaluate fairness metrics. To that end, in some embodiments the system 100 uses the R package glmnet (available at cran.r-project.org/web/packages/glmnet/index.html) to fit a predictive model for whether a loan originated (1=Yes and 0=No) on approximately 1 million home purchase mortgage applications, excluding refinance and reverse mortgages. Let us stress that our goal is to calculate fairness metrics and not to design the best predictor on this data. That said, generalized linear models are desirable in loan applications thanks to their interpretability. Our focus is on fairness statistics to capture the model disparity between the protected (non-white) and the non-protected (white) group. The Oracle uses the exact labels from the loan applicant's self-reported race. Using zip code as the surrogate variable, the inferred metrics are calculated, as described above. Both approaches utilize the same generalized linear model as their model predictions.

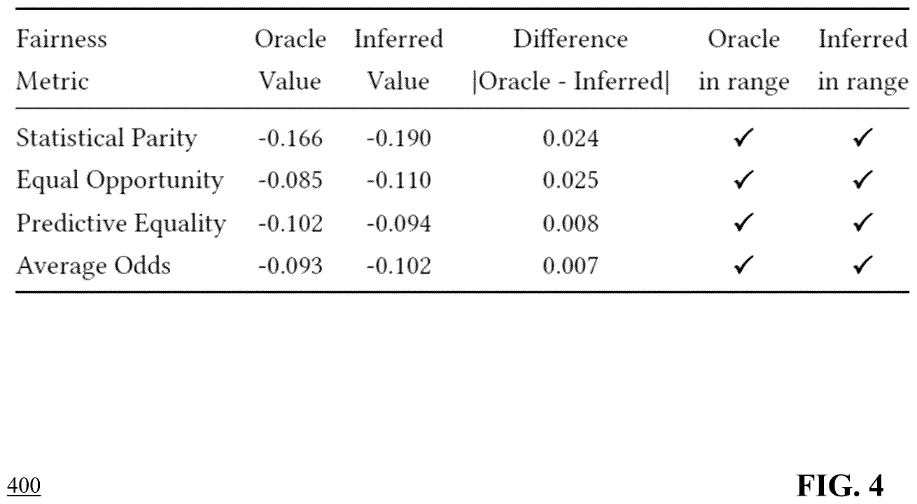

FIG. 4 is a table 400 which compares the fairness statistics on the HMDA data by the Oracle, using self-reported race, versus the Inferred metrics, calculated with zip code as the surrogate. The table 400 presents the actual and the inferred value, their difference, and whether the resulting fairness evaluation remains in ideal ranges according to the 80/20 rule (see Department of Labor, 1978, Uniform Guidelines on Employee Selection Procedures, available at uniformguidelines.com/questionandanswers.html). As shown in the table 400, for Predictive Equality and Average Odds, the difference between the Oracle fairness statistics calculated with actual race and the inferred values is negligible, the equivalent of a rounding error. However, for Statistical Parity and Equal Opportunity, the inferred metrics are somewhat different from the Oracle values. Nevertheless, when checking for ideal ranges for fairness evaluation, inferred metrics lead us to the same conclusion as the Oracle. We conjecture that the cases where the inferred and actual fairness metrics are slightly different are most likely due to omitted variable bias that are associated with model fairness, such as location and race. This bias also affects other methods for calculating fairness when the true protected status is unknown.

While the above results from HMDA are promising, it is possible that the HMDA data and the glmnet model produce fairness statistics that are inherently close to the inferred metrics. Therefore, to run a controlled experiment, we need synthetic data to study how inferred metrics perform under a variety of scenarios

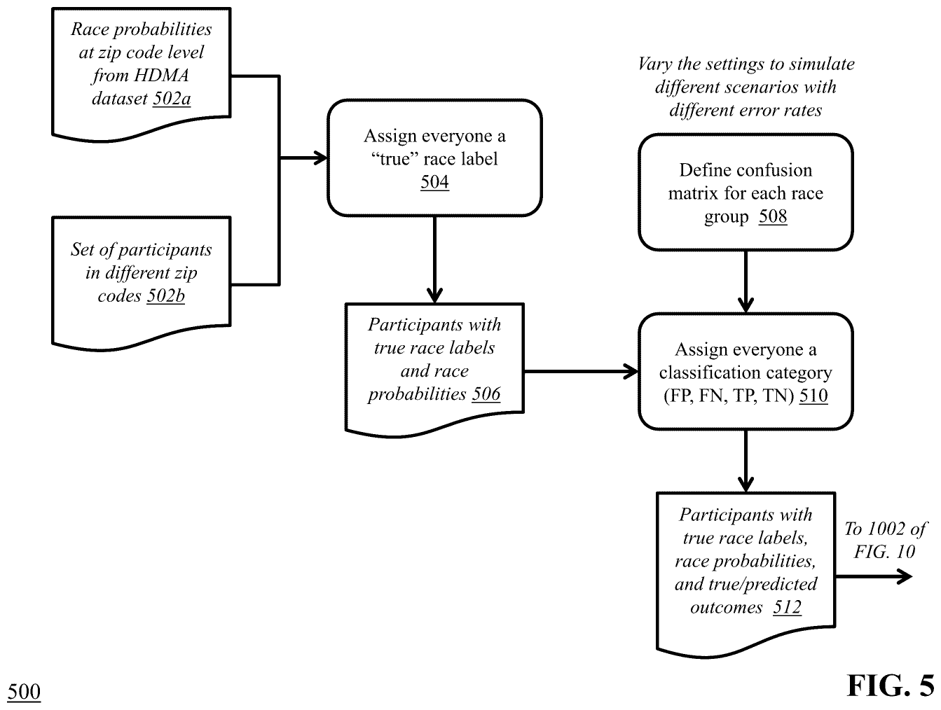

FIG. 5 is a detailed flow diagram of a method 500 for generating the first input data set for evaluating fairness of a binary classification model 108a. Surrogate variable generation module 112 retrieves (502a) race probabilities at the zip code level from, e.g., the ACS dataset/2018 Q4 HUD-USPS Crosswalk file stored in database 116. Module 112 also retrieves (502b) one or more sets of participants in different zip codes from, e.g., the HDMA dataset stored in database 116. Module 112 assigns (504) every participant a “true” race label based upon the self-reported race data in HDMA to generate a set of participants with true race labels and race probabilities (506).

For synthetic benchmarks, we consider a surrogate variable Z with 3,800 levels and 20 to 50 individuals per level. The probability of protected class membership is set between 0.01 and 0.999, with a distribution skewed toward small probabilities of being in the protected group. The resulting hypothetical population hosts 126,000 individuals. These values were chosen so the synthetic samples would have less favorable characteristics for inferred metrics than the HMDA data.

In HDMA experiments, we used the features of individuals to train a glmnet model for binary prediction. In synthetic experiments, we do not have access to features for model building; instead, based on the population characteristics, we simulate the results of a binary classifier with controlled unfairness. Then, given the simulation results, which are precisely the confusion matrices, we calculate the Oracle versus the Inferred fairness metrics.

This simulation process enables us to study how inferred metrics perform under different scenarios ranging from a fair model where the classifier produces the same results for both cohorts to an extremely unfair model where the classifier highly favors the unprotected cohort. A classifier can be unfair by:
(1) False Positive Rate (FPR): incorrectly classifies unprotected group members into the positive case more often, i.e., the difference in false positive rate.
(2) False Negative Rate (FNR): incorrectly classifies protected individuals into the negative case more often, i.e., the difference in the false negative rate.
(3) P(Y=1): The other degree of freedom stems from the bias in the target variable, where positive outcomes for the protected group are observed more rarely than the unprotected group, i.e., the rate at which target is positive.

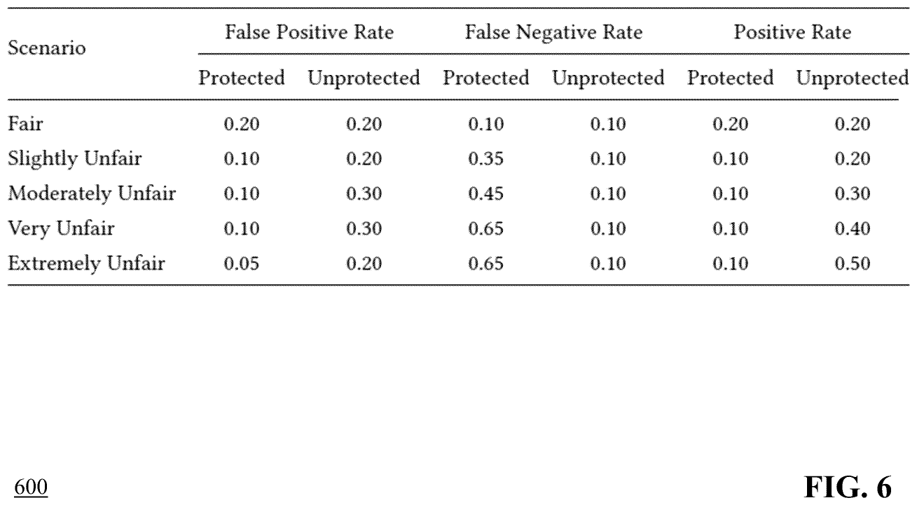

FIG. 6 is a table 600 which provides simulation rates for [symbol] FPR, FNR, P (ML(X)=1) [symbol] in the synthetic benchmarks between protected, T, and unprotected, ⊥, groups. The table 600 presents the values of [symbol] FPR, FNR, P (Y=1) [symbol] that jointly determine the probability of an individual being classified into one of the four quadrants in the confusion matrix within each fairness scenario. Notice that the protected and unprotected groups are subject to different rates depending on the unfairness level we want to simulate. The settings depict unfairness ranges that practitioners are likely to encounter, ranging from 0.1 to 0.55. The statistics are set to favor the unprotected group since, by symmetry, the reverse case is the same calculation but of the opposite sign. We also simulate a fair model as a baseline, where the confusion matrices are the same for the protected and unprotected groups.

Turning back to FIG. 2, surrogate variable generation module 112 generates (step 204) a second input data set for evaluating fairness of the binary classification model 108a, including assigning a class membership label to each of the plurality of participants based upon ground truth class values. To generate the second input data set, module 112 defines (508) a confusion matrix for each race group, where each quadrant in the confusion matrix corresponds to a classification category (FP, FN, TP, TN). Module 112 then assigns (510) each participant from the first input data set 506 into a quadrant in the confusion matrix to generate the second input data set (512) comprising the set of participants with true race labels, race probabilities, and true/predicted outcomes.

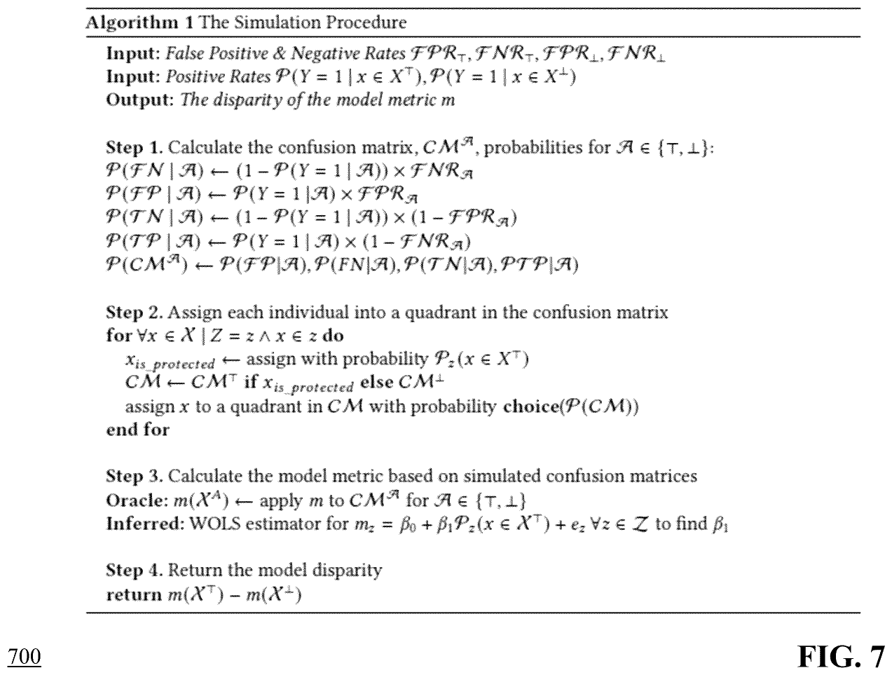

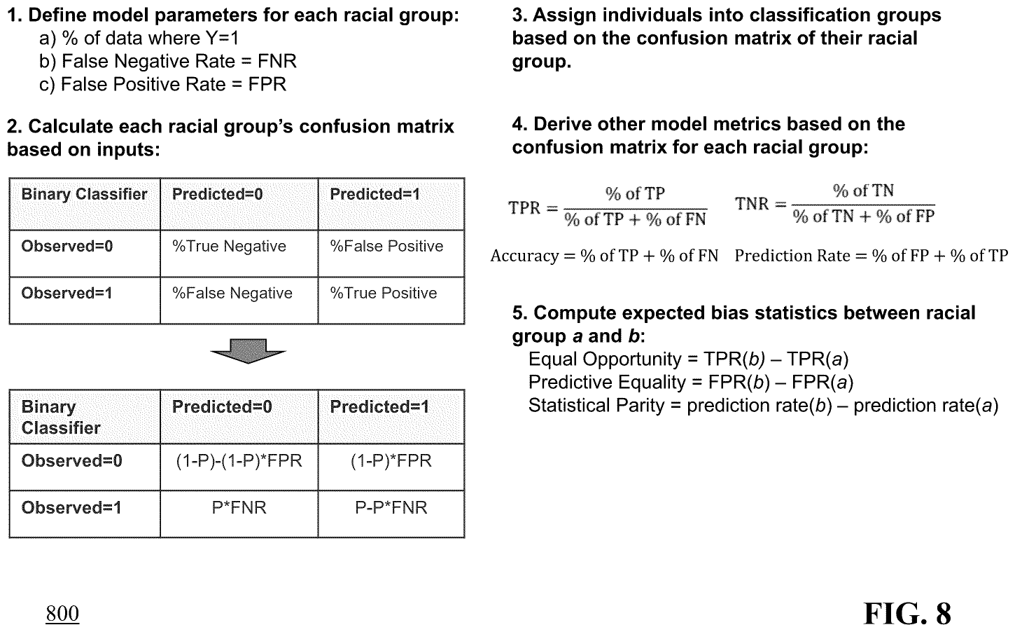

Turning back to FIG. 2, once the input data sets have been generated, classification model execution module 110 of server computing device 106 executes (step 206) the binary classification model 108a on the first input data set to generate inferred fairness metrics for the binary classification model 108a. Classification model execution module 110 executes (step 208) the binary classification model 108a on the second input data set to generate actual fairness metrics for the binary classification model 108a. FIG. 7 is a diagram of an algorithmic procedure 700 to run simulations of a biased binary classifier to define the confusion matrix and assign participants into a quadrant in the matrix. As shown in FIG. 7, Algorithm 1 presents the details of the simulations for Oracle and Inferred values. Conceptually, in a fair model, individuals from the protected and unprotected groups are classified into four quadrants of the confusion matrix at the same rate. Contrarily, in an unfair model, individuals are classified into the four quadrants at different rates, resulting in two different confusion matrices. As shown in FIG. 7, the output from execution of the binary classification model 108a is the model metric m. FIG. 8 is a diagram of a workflow 800 for implementing the algorithm of FIG. 7 to define the confusion matrix, assign participants into a quadrant in the matrix, generate model metrics, and return model disparity. In some embodiments, the model metric m is calculated for the inferred results using the WOLS estimator as described above.

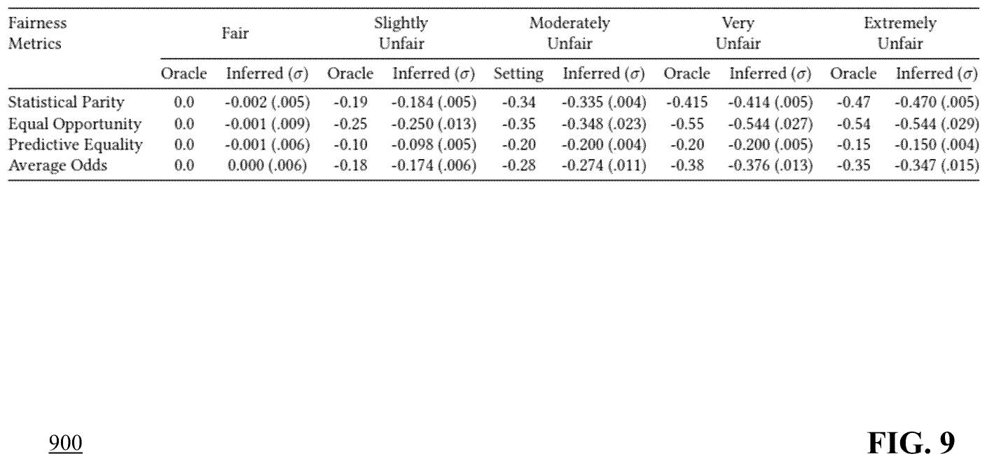

FIG. 9 is a table 900 which provides simulation results from the Oracle and Inferred metrics, averaged over thirty runs, on various unfairness settings. Table 900 presents the simulation results for five scenarios using the settings from table 600 and the procedure in algorithm 700 across all fairness metrics. As before, we compare the Oracle, which calculates the actual disparity from the confusion matrix, versus our inferred metrics that leverage the surrogate information. The results are averaged over 30 runs for robustness, and we also report the standard deviation (a). The main takeaways from these numerical results are as follows.

First, in accordance with our simulation design, we observe that the metric disparity gets worse (larger values) from fair to unfair scenarios. Second, in scenarios in table 400, we deliberately set low positive rates for the protected group. Rates with small denominators are inherently less stable than rates with larger denominators. When comparing standard deviations, this is why the Equal Opportunity, where the denominator is the number of positive cases, has a higher standard deviation than the other statistics. Finally, and most importantly, as can be seen in table 900, our inferred metrics closely follow the Oracle values. This holds across all metrics in all scenarios, demonstrating the effectiveness of our approach.

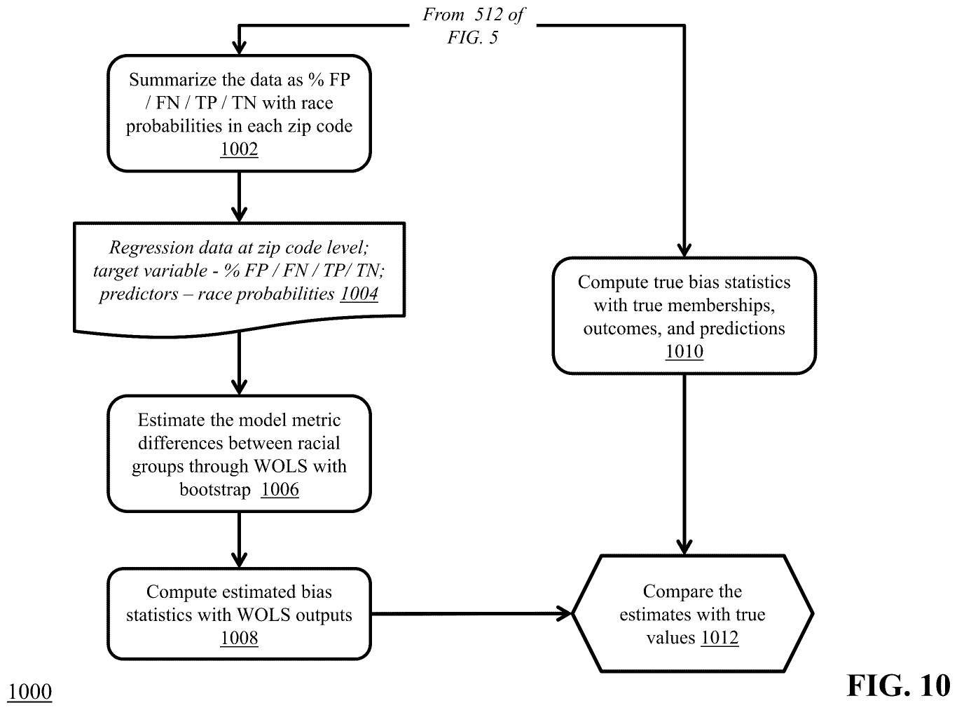

Turning back to FIG. 2, once module 110 has executed the binary classification model 108a on the first input data set to generate inferred fairness metrics and executed the binary classification model 108a on the second input data set to generate actual fairness metrics, fairness evaluation module 114 of server computing device 106 determines (step 210) a disparity in one or more of the fairness metrics for the binary classification model 108a based upon a comparison of the inferred fairness metrics to the actual fairness metrics. FIG. 10 is a detailed flow diagram of a method 1000 for determining a disparity in one or more of the fairness metrics for the binary classification model 108a based upon a comparison of the inferred fairness metrics to the actual fairness metrics.

Module 114 summarizes (1002) the output data as % FP/FN/TP/TN with race probabilities in each zip code to generate regression data at the zip code level; the target variables (i.e., % FP/FN/TP/TN); and predictors for race probabilities (1004). Module 114 estimates (1006) the model metric differences between racial groups through WOLS with bootstraps (as described previously). Module 114 then computes (1008) estimated bias statistics with WOLS outputs. Concurrently, fairness evaluation module 114 computes (1010) true bias statistics with true race labels/memberships, outcomes, and predictions generated by module 112. Fairness evaluation module 114 then compares (1012) the estimated bias statistics with the true bias statistics to determine the disparity.

Another important aspect of the methods and systems described herein is unbiased nature of the inferred fairness metrics versus other approaches, such as model-based membership prediction. Typically, when membership values are not present, much of the existing efforts focus on developing predictive models for class membership first, and then, calculating fairness metrics based on model predictions. Notice that building models to predict class membership is far from ideal since it raises many questions both technical and ethical in nature. First, this practice introduces yet another model to evaluate the fairness of the original model. There are now two sources of potential errors; errors in the model predicting the class membership, and the errors in the original model at-hand, for fairness evaluation. It is not clear how the errors in the first layer interact with the second layer, and we must also ask whether the predictor model for the class membership is itself fair. More broadly, it remains debatable whether certain machine learning models, such as those that are predicting highly personal attributes at an individual level, e.g. race, should exist. Finally, building a class prediction model is still a supervised exercise; therefore, there must exist a sufficiently large and representative training population where class membership is known. The need for inferred metrics exists because many organizations do not have access to protected characteristics at all.

Despite their drawbacks, let us now compare model-based estimates to our inferred metrics. We show, both analytically and numerically, that our inferred metrics are unbiased (i.e. their expected value is equal to the true value of the metric), while model-based approaches are always biased toward zero. We also point out that the size of the bias is directly related to the Positive Predictive Value (PPV, also called Precision) and the Negative Predictive Value (NPV) of the model that predicts class membership.

As a concrete example, let us focus on Statistical Parity (Equation 6) as described above. Consider a machine learning model that predicts class membership for each individual based on available characteristics. Let S\hat{ }P denote the model-based estimate for Statistical Parity as follows:

$$S \hat{} P = \frac{1}{\vert {\hat{X}}^{⊤} \vert} {\sum }_{x ϵ {\hat{X}}^{⊤}} I ( ML ( x ) = 1 ) - \frac{1}{\vert {\hat{X}}^{⊥} \vert} {\sum }_{x ϵ {\hat{X}}^{⊥}} I ( ML ( x ) = 1 ) \qquad Equation 8$$

Unlike Statistical Parity (Equation 6), here we are using predictions, x∈X\hat{ }T or x∈X\hat{ }⊥, for the classification of samples. Each of the above sums, then, is a combination of samples that are classified correctly as protected vs. not protected, and that are misclassified. Consequently, the model-based estimate of Statistical Parity can be written as follows:

$$( {PPV}_{\hat{x}} + {NPV}_{\hat{x}} - 1 ) ( \frac{1}{\vert {X}^{⊤} \vert} {\sum }_{x ∈ {X}^{⊤}} I ( ML ( x ) = 1 ) - \frac{1}{\vert {X}^{⊥} \vert} {\sum }_{x ∈ {X}^{⊥}} I ( ML ( x ) = 1 ) ) \qquad Equation 9$$

where PPV_{\hat{x}} and NPV_{\hat{x}} are the Positive Predictive Value and Negative Predictive Value for class membership. Positive Predictive Value is same as Precision (the probability that a model-classified positive is a true positive), and Negative Predictive Value is its equivalent for the negative class (the probability that a model-classified negative is a true negative).

In a perfect model, PPV_{\hat{x}} and NPV_{\hat{x}} are both equal to one, and Equation 9 yields the correct estimate for Statistical Parity. As these two numbers decrease, the coefficient term, (PPV_{\hat{x}} +NPV_{\hat{x}}−1) becomes less than one, and the estimated value for Statistical Parity shrinks toward zero. Note that it is possible for the classifier to perform so poorly that PPV_{\hat{x}}+NPV_{\hat{x}}<1, and the sign of the estimate for Statistical Parity is the opposite of what it should be for the correct model.

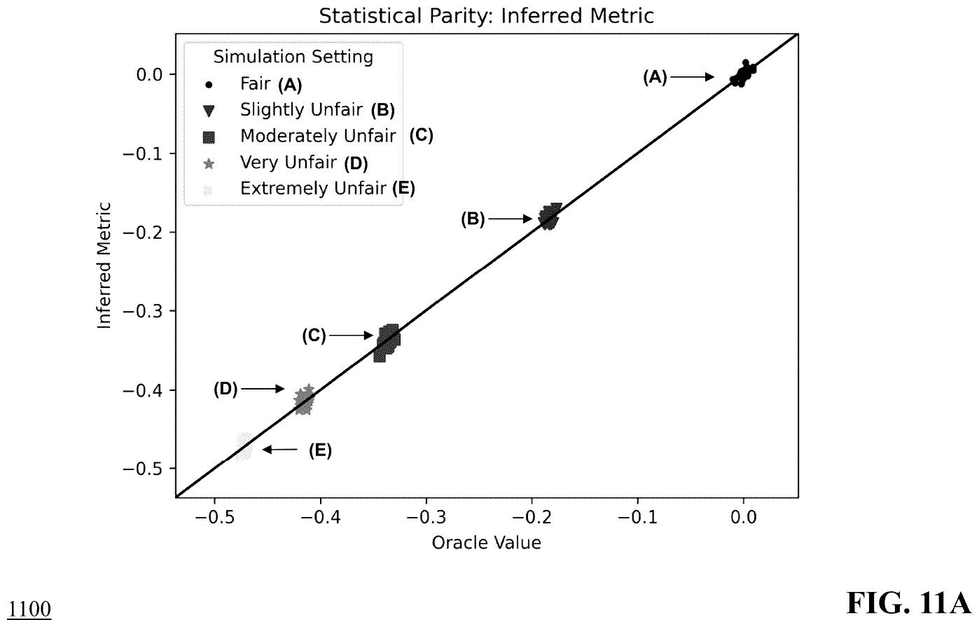

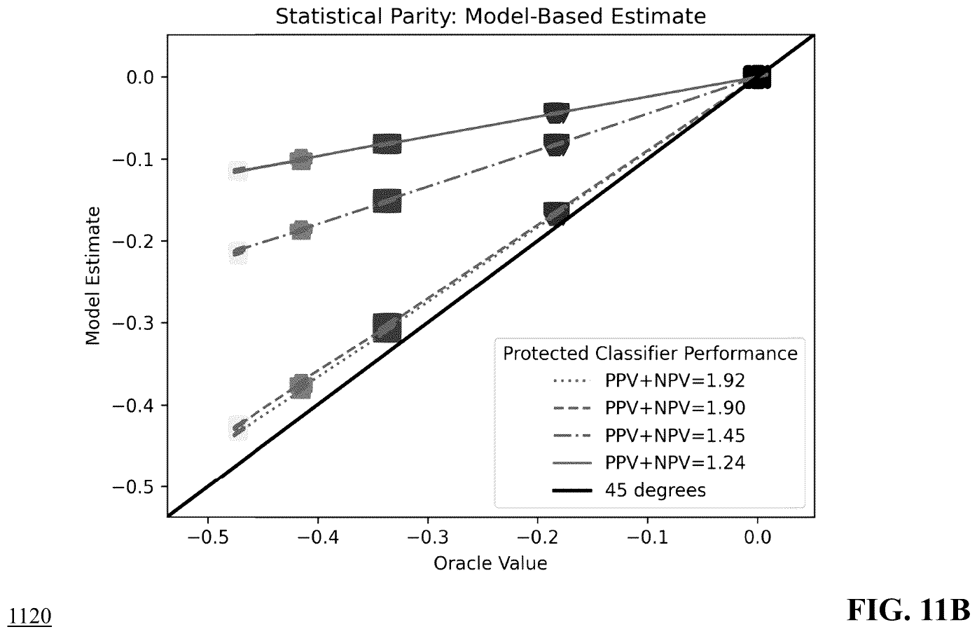

FIGS. 11A and 11B are diagrams that show graphs 1100 and 1120 comparing the estimates of Statistical Parity for the inferred metric and a set of model-based estimators of varying performance under the fairness scenarios described in table 600. The graphs 1100 and 1120 clearly show that the inferred metric is unbiased, while the model-based estimator can be significantly biased toward zero depending on model performance.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

The computer program can be deployed in a cloud computing environment (e.g., Amazon® AWS, Microsoft® Azure, IBM® Cloud™). A cloud computing environment includes a collection of computing resources provided as a service to one or more remote computing devices that connect to the cloud computing environment via a service account-which allows access to the aforementioned computing resources. Cloud applications use various resources that are distributed within the cloud computing environment, across availability zones, and/or across multiple computing environments or data centers. Cloud applications are hosted as a service and use transitory, temporary, and/or persistent storage to store their data. These applications leverage cloud infrastructure that eliminates the need for continuous monitoring of computing infrastructure by the application developers, such as provisioning servers, clusters, virtual machines, storage devices, and/or network resources. Instead, developers use resources in the cloud computing environment to build and run the application, and store relevant data.

Method steps can be performed by one or more processors executing a computer program to perform functions of the invention by operating on input data and/or generating output data. Subroutines can refer to portions of the stored computer program and/or the processor, and/or the special circuitry that implement one or more functions. Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Exemplary processors can include, but are not limited to, integrated circuit (IC) microprocessors (including single-core and multi-core processors). Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), an ASIC (application-specific integrated circuit), Graphics Processing Unit (GPU) hardware (integrated and/or discrete), another type of specialized processor or processors configured to carry out the method steps, or the like.

Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices (e.g., NAND flash memory, solid state drives (SSD)); magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above-described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). The systems and methods described herein can be configured to interact with a user via wearable computing devices, such as an augmented reality (AR) appliance, a virtual reality (VR) appliance, a mixed reality (MR) appliance, or another type of device. Exemplary wearable computing devices can include, but are not limited to, headsets such as Meta™ Quest 3™ and Apple® Vision Pro™ Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), a private IP network, an IP private branch exchange (IPBX), a wireless network (e.g., radio access network (RAN), Bluetooth™, near field communications (NFC) network, Wi-Fi™, WiMAX™, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), cellular networks, and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE), cellular (e.g., 4G, 5G), and/or other communication protocols.

Devices of the computing system can include, for example, a computer, a computer with a browser device, a telephone, an IP phone, a mobile device (e.g., cellular phone, personal digital assistant (PDA) device, smartphone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Safari™ from Apple, Inc., Microsoft® Edge® from Microsoft Corporation, and/or Mozilla® Firefox from Mozilla Corporation). Mobile computing devices include, for example, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

The methods and systems described herein can utilize artificial intelligence (AI) and/or machine learning (ML) algorithms to process data and/or control computing devices. In one example, a classification model, is a trained ML algorithm that receives and analyzes input to generate corresponding output, most often a classification and/or label of the input according to a particular framework.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting the subject matter described herein.

What is claimed is:

1. A computer system for evaluating probabilistic fairness of machine learning (ML) classification models, the system comprising a server computing device with a memory that stores computer-executable instructions and a processor that executes the computer-executable instructions to:
connect to a remote computing environment hosting a binary classification model via a programmatic interface;
generate a first input data set for evaluating fairness of the binary classification model, including assigning a class membership label to each of a plurality of participants based upon a probability of class membership derived from a surrogate class variable;
generate a second input data set for evaluating fairness of the binary classification model, including assigning a class membership label to each of the plurality of participants based upon ground truth class values;
execute the binary classification model on the first input data set to generate inferred fairness metrics for the binary classification model;
execute the binary classification model on the second input data set to generate actual fairness metrics for the binary classification model;
determine a disparity in one or more of the fairness metrics for the binary classification model based upon a comparison of the inferred fairness metrics to the actual fairness metrics; and
modify one or more features of the binary classification model based upon the disparity and rebuild the binary classification model.

2. The system of claim 1, wherein the class membership label corresponds to a protected class or an unprotected class.

3. The system of claim 1, wherein the surrogate class variable is used to separate the plurality of participants into one or more groups.

4. The system of claim 1, wherein the inferred fairness metrics comprise one or more of: statistical parity, equal opportunity, predictive equality, or average odds.

5. The system of claim 4, wherein the actual fairness metrics are statistical parity, equal opportunity, predictive equality, or average odds.

6. The system of claim 5, wherein determining a disparity in one or more of the fairness metrics for the binary classification model comprises comparing each inferred fairness metric to a corresponding actual fairness metric to determine a difference in values.

7. The system of claim 1, wherein modifying one or more features of the binary classification model based upon the disparity and rebuilding the binary classification model results in a modified binary classification model that exhibits improved fairness in classifying data.

8. A computerized method of evaluating probabilistic fairness of machine learning (ML) classification models, the method comprising:
connecting, by a server computing device, to a remote computing environment hosting a binary classification model via a programmatic interface;
generating, by a server computing device, a first input data set for evaluating fairness of a binary classification model, including assigning a class membership label to each of a plurality of participants based upon a probability of class membership derived from a surrogate class variable;
generating, by the server computing device, a second input data set for evaluating fairness of the binary classification model, including assigning a class membership label to each of the plurality of participants based upon ground truth class values;
executing, by the server computing device, the binary classification model on the first input data set to generate inferred fairness metrics for the binary classification model;
executing, by the server computing device, the binary classification model on the second input data set to generate actual fairness metrics for the binary classification model;
determining, by the server computing device, a disparity in one or more of the fairness metrics for the binary classification model based upon a comparison of the inferred fairness metrics to the actual fairness metrics; and
modifying, by the server computing device, one or more features of the binary classification model based upon the disparity and rebuilding the binary classification model.

9. The method of claim 8, wherein the class membership label corresponds to a protected class or an unprotected class.

10. The method of claim 8, wherein the surrogate class variable is used to separate the plurality of participants into one or more groups.

11. The method of claim 8, wherein the inferred fairness metrics comprise one or more of: statistical parity, equal opportunity, predictive equality, or average odds.

12. The method of claim 11, wherein the actual fairness metrics are statistical parity, equal opportunity, predictive equality, or average odds.

13. The method of claim 12, wherein determining a disparity in one or more of the fairness metrics for the binary classification model comprises comparing each inferred fairness metric to a corresponding actual fairness metric to determine a difference in values.

14. The method of claim 8, wherein modifying one or more features of the binary classification model based upon the disparity and rebuilding the binary classification model results in a modified binary classification model that exhibits improved fairness in classifying data.
